(19) United States
(12) Patent Application Publication
(10) Pub. No.: US 2006/0210464 A1
(43) Pub. Date: Sep. 21, 2006

(54) Carbon nanohorn assembly producing method

(75) Inventors: Takeshi Azami, Tokyo (JP); Daisuke Kasuya, Tokyo (JP); Tsutomu Yoshitake, Tokyo (JP); Yoshimi Kubo, Tokyo (JP); Sumio Iijima, Tokyo (JP); Masako Yudasaka, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, MINATO-KU, TOKYO (JP)

(21) Appl. No.: 10/555,287

(22) PCT Filed: May 13, 2004
(86) PCT No.: PCT/JP04/06463

§ 371 Date: Nov. 2, 2005

(30) Foreign Application Priority Data
May 20, 2003 (JP) 2003-142321

(51) Int. Cl. C01B 31/02

(52) U.S. Cl. 423/445 R

(57) ABSTRACT

In a production chamber (107), a cylindrical graphite rod (101) is fixed to a rotation device (115), enabling the graphite rod (101) to rotate around its longitudinal axis and to move right and left along its longitudinal axis. The lateral surface of the graphite rod (101) is irradiated with laser light (103) from a laser light source (111), and a nanocarbon recovering chamber (119) is installed in the direction of generation of plume (109). The pulse width of the laser light (103) is from 0.5 sec. to 1.25 sec.

### TECHNICAL FIELD

The present invention relates to a method of producing a carbon nanohorn assembly.

### BACKGROUND ART

Recently technological application of nanocarbon is actively studied. The nanocarbon means a carbon substance having a nanoscale fine structure, typified by a carbon nanotube, a carbon nanohorn, and the like. Among others, the carbon nanohorn has a tubular structure in which one end of the carbon nanotube formed by a cylindrically rounded graphite sheet is formed in a circular conic shape. Usually the carbon nanohorn is aggregated in a form, in which the circular conic portion is projected to a surface like a horn while the tube is located in the center by Van der Waals force acting between circular conic portions. The carbon nanohorn is expected to be applied to various technical fields due to specific characteristics of the carbon nanohorn.

It is reported that the carbon nanohorn assembly is produced by a laser ablation method of irradiating the carbon substance (hereinafter also referred to as “graphite target”) of a raw material with a laser light in an inert gas atmosphere (Patent Document 1). In Patent Document 1, it is described that a pulse width ranges from 20 to 500 msec and preferably continuous oscillation is performed in a laser light with which the graphite target is irradiated.

Patent Document 1: Japanese Laid-Open patent publication No. 2001-64004

### DISCLOSURE OF THE INVENTION

However, according to the intense study of the inventor, in the conventional laser ablation method, there is still room for improvement to a ratio (hereinafter also referred to as “yield”) of the carbon nanohorn assembly included in a recovered soot-like substance. When substantial amounts of amorphous carbon and graphite are included besides the carbon nanohorn assembly, it is necessary that the obtained soot-like substance is purified while other substances are removed. It takes a long time to perform the purification process. For example, sometimes the purification of the soot-like substance of 10 g may be required for one day or more.

This invention is performed in view of the foregoing circumstances and provides a technology for obtaining the carbon nanohorn assembly at high efficiency.

As a result of active studies on a technique for obtaining the carbon nanohorn assembly at high efficiency, the inventor finds that precise control of light energy with which the graphite target is irradiated and a temperature of the graphite target to be irradiated are important and reaches the present invention.

According to the present invention, there is provided a method of producing a carbon nanohorn assembly including irradiating a surface of a graphite target with pulse light to vaporize carbon vapor from the graphite target and recovering the carbon vapor to obtain a carbon nanohorn, wherein an irradiation position of the pulse light is moved at substantially constant speed when the surface of the graphite target is irradiated with the pulse light, a power density of the pulse light is set in a range of 5 kW/cm² or more and 25 kW/cm² or less, and a pulse width of the pulse light is set in a range of 0.5 seconds or more and 1.25 seconds or less.

In the producing method according to the present invention, while the irradiation position is moved, the surface of the graphite target is irradiated with the pulse light which power density ranges from 15 kW/cm² or more and 25 kW/cm² or less. Therefore, the carbon nanohorn assembly can be obtained at high efficiency. In this specification, “power density” shall mean the power density of the pulse light with which the surface of graphite target is actually irradiated, namely, the power density at the light irradiation region in the surface of the graphite target.

Further, the graphite target is irradiated with the pulse light while the irradiation position of the pulse light is moved, which allows local temperature elevation to be suppressed in the graphite target. Therefore, the carbon nanohorn assembly can stably be obtained. Because the surface of the graphite target is roughened by the light irradiation, it is preferable that the number of irradiation times to the surface already irradiated with the light once is as small as possible, and it is more preferable that re-irradiation of the surface with the light is not performed.

In the present invention, as described above, the irradiation position of the pulse light is move at substantially constant speed, the irradiation is performed while the power density of the pulse light is controled, and the pulse width of the light irradiation is set in the range of 0.5 seconds or more and 1.25 seconds or less. The pulse width is set in the range of 0.5 seconds or more and 1.25 seconds or less, the irradiation position is move at substantially constant speed, and the irradiation is performed while the power density of the pulse light is controlled. Therefore, a production amount and a yield of the carbon nanohorn assembly can be improved by these synergic actions. Although the reason is not always clear, it is presumed that energy necessary to generate the carbon nanohorn assembly is accumulated while the excessive temperature elevation is suppressed in the light irradiation position.

In the method of producing a carbon nanohorn assembly of the present invention, a pause width of the pulse light may be set not less than 0.25 seconds. Therefore, overheat of the graphite target can be suppressed more securely, which allows the yield of the carbon nanohorn assembly to be further improved.

In the method of producing a carbon nanohorn assembly of the present invention, the pulse light may satisfy the following expression (1):
0.5≦(pulse width)/(pulse width+pause width)≦0.8 (1)

In the above expression (1), Letting 0.5≦(pulse width)/(pulse width+pause width) can preferably secure the irradiation time of light. Therefore, the production amount of the carbon nanohorn assembly can be improved. Further, letting (pulse width+pause width)≦0.8 allows overheating of the graphite target to be further suppressed. Therefore, the yield of the carbon nanohorn assembly can be improved.

In the method of producing a carbon nanohorn assembly of the present invention, the irradiation position of the pulse light may be moved at speed ranging from 0.01 mm/sec or more and 55 mm/sec or less. The total energy amount of the light with which the per unit area of the graphite target surface is irradiated can be increased by slowly moving the irradiation position of the pulse light. As a result, light energy can reach the deep position from the surface of the graphite target, which allows the production amount of the carbon nanohorn to be increased. Because graphite is excellent in thermal conductivity, in the speed ranging from 0.01 mm/sec or more and 55 mm/sec or less, it is considered that the influence on the yield and the like due to the temperature elevation associated with the change in speed is relatively small.

In a method of producing a carbon nanohorn assembly of the invention, a side face of a cylindrical graphite target may be irradiated with the pulse light while the graphite target is rotated about a central axis. The graphite target can efficiently be irradiated with the light while the space-saving apparatus is realized by the adoption of this configuration. When such the method is adopted, because an irradiation surface with the light becomes a curved surface, generally it is difficult that to stabilize the production amount and the yield of the carbon nanohorn. However, according to the present invention, the problems on the productivity can effectively be solved.

In the method of producing a carbon nanohorn assembly of the present invention, the irradiation position may be moved while an angle of incident light relative to the irradiation surface of the pulse light, that is, an irradiation angle of the pulse light is kept substantially constant. In the specification, “irradiation angle” shall mean the angle formed between a normal to the surface of the graphite target and the laser light at the irradiation position of the laser light. The carbon nanohorn assembly can stably be produced by performing the irradiation at the substantially constant irradiation angle. The irradiation angle is kept substantially constant shall mean that a fluctuation in irradiation angle is suppressed to an extent in which the power density of the laser light with which the surface of the graphite target is irradiated substantially becomes constant.

In the present invention, it is preferable that the irradiation angle ranges from 30 degrees or more and 60 degrees or less. When the irradiation angle is set in the range of 30 degrees or more and 60 degrees or less, the good controllability of light irradiation energy density is obtained, which allows the yield of the carbon nanohorn assembly to be stably improved.

In the method of producing a carbon nanohorn assembly of the present invention, the irradiation position is moved such that the irradiation positions of the pulse light do not overlap one another in the surface of the graphite target. Therefore, the overheating of the graphite target due to over-irradiation can be suppressed, and the over-irradiation of the pulse light on the roughened surface can be prevented, which allows the carbon nanohorn assembly to be stably produced at high yield.

As described above, according to the present invention, in irradiating the surface of the graphite target with the pulse light, the irradiation condition with the pulse light are set in the particular range while the irradiation position is moved at substantially constant speed, so that the carbon nanohorn assembly can be produced at high efficiency.

### BRIEF DESCRIPTION OF THE DRAWINGS

The above and other objects, features, and advantages of the invention will be apparent from the following description of preferred embodiments and appended drawings in which:

FIG. 1 is a view showing a configuration of a carbon nanohorn assembly producing apparatus according to an embodiment;

FIG. 2 is a view showing a relationship between a production rate of a carbon nanohorn assembly and a pulse width of an example;

FIG. 3 is a view showing a configuration of a carbon nanohorn assembly producing apparatus according to an embodiment; and

FIG. 4 is a view explaining irradiation of a graphite target with a laser light in the carbon nanohorn assembly producing apparatus of FIG. 3.

### BEST MODE FOR CARRYING OUT THE INVENTION

Preferred embodiments of the present invention will be described below.

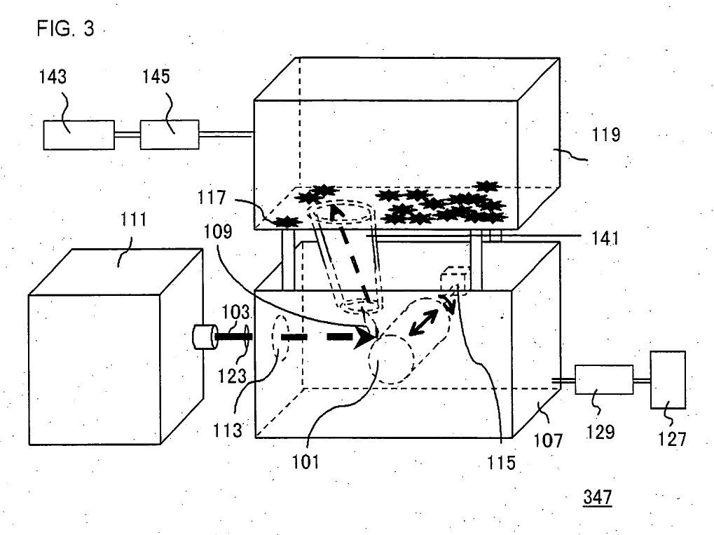

FIG. 3 is a view showing an example of a configuration of a carbon nanohorn assembly producing apparatus. A nanocarbon producing apparatus 347 shown in FIG. 3 includes a producing chamber 107, a nanocarbon recovery chamber 119, a carrier pipe 141, a laser light source 111, and a lens 123. The laser light source 111 emits a laser light 103 to the producing chamber 107 through a laser light window 113. The lens 123 focuses the laser light 103. The nanocarbon producing apparatus 347 also includes an inert gas supply unit 127, a flowmeter 129, a vacuum pump 143, and a pressure gage 145.

A graphite rod 101 is used as a solid-state carbon elemented substance which becomes a target irradiated with the laser light 103. The graphite rod 101 is fixed to a rotating mechanism 115, and can be rotated about a central axis. A position of the graphite rod 101 can also be moved. A side face of the graphite rod 101 is irradiated with the laser light 103 from the laser light source 111. At this point, the nanocarbon recovery chamber 119 is provided toward a direction in which a plume 109 is generated, through the carrier pipe 141. Therefore, a produced carbon nanohorn assembly 117 is recovered by the nanocarbon recovery chamber 119.

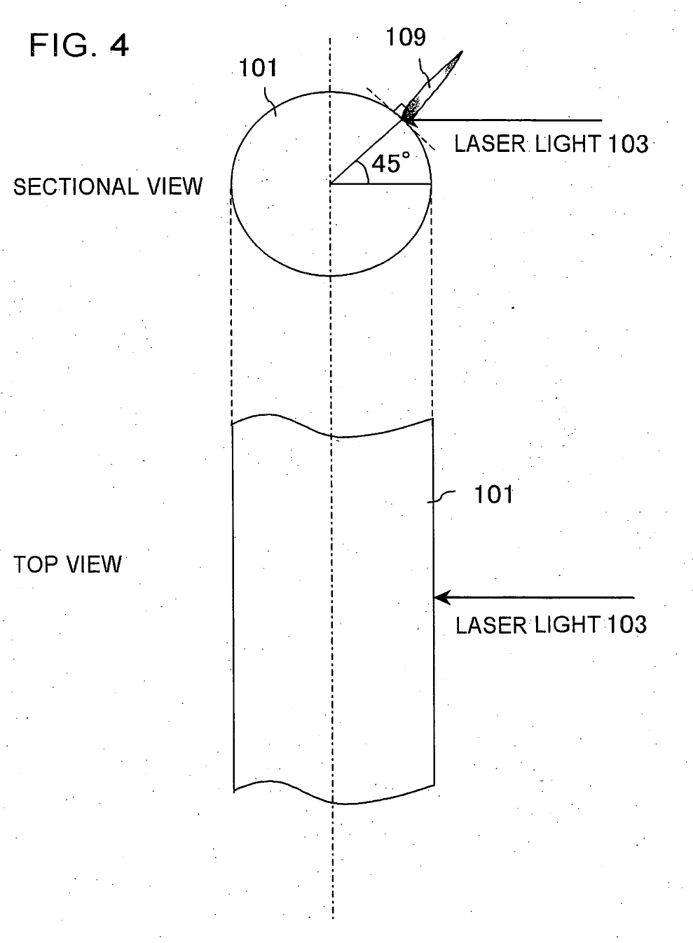

The laser light 103 is emitted such that an irradiation angle is kept constant. This state will be described with reference FIG. 4. FIG. 4 illustrates the case in which a cylindrical surface of the graphite rod 101 is irradiated with the laser light 103 at the irradiation angle of 45 degrees. As shown in FIG. 4, the laser light 103 is incident to the cylindrical surface at right angle to a long axis (central axis) of the graphite rod 101. The irradiation angle is 45 degrees at an irradiation position.

The graphite rod 101 is rotated about the central axis at a predetermined speed while the irradiation angle of the laser light 103 is kept constant, which allows a circumferential direction of the side face of the graphite rod 101 to be continuously irradiated with the laser light 103 at constant power density. Further, the graphite rod 101 can continuously be irradiated along the direction of lengthwise thereof with the laser light 103 at constant power density by causing the graphite rod 101 to slide in the lengthwise direction.

In this case, it is preferable that the irradiation angle ranges from 30 degrees to 60 degrees, both ends inclusive. As described above, the irradiation angle shall means the angle formed between a perpendicular to the surface of the graphite target and the laser light 103 at the irradiation position of the laser light 103. In the case of the use of the graphite rod 101 which is of the cylindrical graphite target, it is the angle formed between a line segment connecting the irradiation position and the center of a circle and a horizontal plane in across section perpendicular to a length direction of the graphite rod 101.

The reflection of the laser light 103 to be irradiated with, namely, the generation of optical feedback can be prevented by setting the irradiation angle not less than 30 degrees. The generated plume 109 can be prevented from directly striking the lens 123 through the laser light window 113. Therefore, it is effective that the lens 123 is protected, and it is also effective that the carbon nanohorn assembly 117 is prevented from adhering to the laser light window 113. Accordingly, the power density of the laser light 103 with which the graphite rod 101 is irradiated can be stabilized to stably produce the carbon nanohorn assembly 117 at high yield.

The irradiation of the graphite rod 101 with the laser light 103 at angles not more than 60 degrees can suppress the generation of amorphous carbon to improve the ratio of the carbon nanohorn assembly 117 in the product, that is, the yield of the carbon nanohorn assembly 117. It is particularly preferable that the irradiation angle is set at 45 degrees ±5 degrees. The irradiation with the angle of about 45 degrees can further improve the ratio of the carbon nanohorn assembly 117 in the product.

The nanocarbon producing apparatus 347 has the configuration in which the side face of the graphite rod 101 is irradiated with the laser light 103. Therefore, the irradiation angle to the side face can be changed by controlling a height of the graphite rod 101 in the state in which the position of the lens 123 is fixed. When the irradiation angle of the laser light 103 is changed, an irradiation area of the laser light 103 is changed in the surface of the graphite rod 101, which allows the power density to be changed and securely controlled.

Specifically, for example, in the case where the position of the lens 123 is fixed, the irradiation angle is set at 30 degrees, which allows the power density to be increased. The irradiation angle is set at 60 degrees, for example, which allows the power density to be controlled low.

Returning to FIG. 3, the rotating mechanism 115 holds the graphite rod 101 to rotate the graphite rod 101 about the central axis. For example, the graphite rod 101 can be rotated such that a point irradiated with the laser light 103 in the surface of the graphite rod 101 is separated from an irradiation direction of the laser light 103. Specifically, in FIG. 3, the graphite rod 101 can be rotated clockwise about the central axis. Therefore, the generation of the optical feedback can be suppressed more securely.

While the new surface to be irradiated with the laser light 103 is stably provided, the carbon nanohorn assembly 117 can securely be recovered. The graphite rod 101 can be rotated about the central axis by fixing the graphite rod 101 to the rotating mechanism 115. The graphite rod 101 can be configured to be movable in the direction along the central axis or the vertical direction, namely, the vertical direction of FIG. 3.

In the nanocarbon producing apparatus 347, the graphite rod 101 can be moved in a translational manner while rotated clockwise about the central axis, so that the graphite rod 101 can be irradiated with the laser light 103 while the irradiation position is shifted by controlling the conditions of the rotational movement and the translational movement. Therefore, as described later, the condition that the graphite rod 101 is irradiated with the laser light 103 can easily be controlled. Accordingly, the configuration suitable for the large-scale production of the carbon nanohorn assembly 117 having the desired property can be achieved.

The carrier pipe 141 is communicated with the producing chamber 107 and the nanocarbon recovery chamber 119 to connect them. The side face of the graphite rod 101 is irradiated with the laser light 103 from the laser light source 111. At this point, the nanocarbon recovery chamber 119 is provided toward the direction, in which the plume 109 is generated, through the carrier pipe 141. Therefore, the produced carbon nanohorn assembly 117 is recovered by the nanocarbon recovery chamber 119.

Since the plume 109 is generated in the direction perpendicular to a tangent of the graphite rod 101, that is, a normal direction at the irradiation position of the laser light 103, when the carrier pipe 141 is provided in this direction, carbon vapor can efficiently be introduced to the nanocarbon recovery chamber 119 to recover powder of the carbon nanohorn assembly 117. For example, when the irradiation angle is set at 45 degrees, the carrier pipe 141 can be provided in the direction of 45 degrees relative to the normal.

The nanocarbon producing apparatus 347 is configured to irradiate the side face of the graphite rod 101 with the laser light 103 while rotating the graphite rod 101 in the circumferential direction. The graphite rod 101 is irradiated with the laser light 103 at a positional relationship in which the direction of the laser light 103 does not coincide with the direction where the plume 109 is generated. Therefore, the carbon nanohorn assembly 117 can efficiently be recovered at the position which does not interfere with an optical path of the laser light 103.

In the nanocarbon producing apparatus 347, the angle of the plume 109 generated in the side face of the graphite rod 101 can previously predicted, which allows the position and angle of the carrier pipe 141 to be precisely controlled. Therefore, the carbon nanohorn assembly 117 can efficiently be produced and securely be recovered on the later-mentioned conditions.

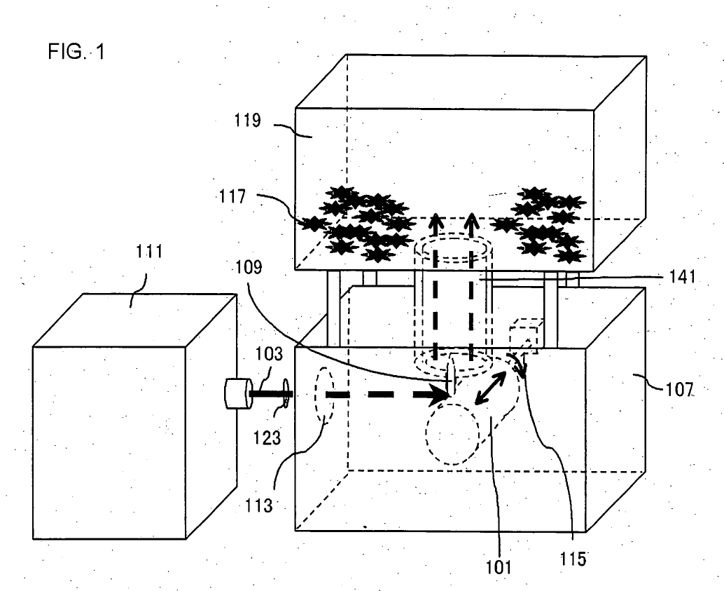

FIG. 1 is a view showing an example of another configuration of the apparatus for producing the carbon nanohorn assembly 117. The basic configuration of the producing apparatus shown in FIG. 1 is same as the apparatus of FIG. 3. However, it differs in the positional relationship between the graphite rod 101 and the laser light 103 and the direction in which the carrier pipe 141 is arranged. In the apparatus shown in FIG. 1, the position located slightly below a top of the side face of the graphite rod 101 is irradiated with the laser light 103, and the plume 109 is generated in the normal direction of the irradiation surface. In the apparatus shown in FIG. 1, the nanocarbon recovery chamber 119 is located in the direction near the directly above along the direction in which the plume 109 is generated. Therefore, the generated carbon nanohorn assembly 117 is recovered at the nanocarbon recovery chamber 119. Although not shown in FIG. 1, the inert gas supply unit 127, the flowmeter 129, the vacuum pump 143, and the pressure gage 145 may also be included in the apparatus.

Then, a method of producing the carbon nanohorn assembly 117 with the producing apparatus shown in FIG. 1 or FIG. 3 will specifically be described.

In the producing method of the embodiment, the surface of the graphite rod 101 is irradiated with the pulse laser light 103 to vaporize the carbon vapor from the graphite rod 101, and the carbon vapor is recovered to obtain the carbon nanohorn. At this point, the carbon nanohorn is obtained as the carbon nanohorn assembly 117. In irradiating the surface of the graphite rod 101 with the pulse light, the irradiation position of the pulse light is moved at substantially constant speed, the power density of the pulse light is set in the range of 5 kW/cm² to 25 kW/cm², both ends inclusive, and a pulse width of the pulse light is set in the range of 0.5 seconds to 1.25 seconds, both ends inclusive.

In the production of the carbon nanohorn assembly 117 with the producing apparatus of FIG. 1 or FIG. 3, high-purity graphite, for example, rod-shaped sintered carbon or compression molded carbon can be used as the graphite rod 101.

A high-power CO₂ gas laser and the like are used as the laser light 103. The graphite rod 101 is irradiated with the laser light 103 in the inert gas atmosphere using rare gas such as Ar and He, for example, at a pressure range of 10³ Pa to 10⁵ Pa, both ends inclusive. It is preferable that the inert gas atmosphere is generated after the producing chamber 107 is previously evacuated, for example, at a pressure not more than 10⁻² Pa.

It is preferable that output of the laser light 103, a spot diameter, and the irradiation angle are controlled such that the power density of the laser light 103 is substantially kept constant within the above described range of 5 kW/cm² to 25 kW/cm², both ends inclusive, at the side face of the graphite rod 101.

For example, the output of the laser light 103 is set in the range of 1 kW to 50 kW, both ends inclusive. The pulse width of the laser light 103 is set not less than 0.5 seconds, and preferably not less than 0.75 seconds. Therefore, cumulative energy of the laser light 103 with which the surface of the graphite rod 101 is irradiated can sufficiently be secured, which allows the carbon nanohorn assembly 117 to be sufficiently be produced. The pulse width of the laser light 103 is set not more than 1.5 seconds, and preferably not more than 1.25 seconds. Therefore, the decrease in yield of the carbon nanohorn assembly, caused by the fluctuation in energy density in the surface due to the overheating of the surface of the graphite rod 101, can be suppressed. Further, it is preferable that the pulse width of the laser light 103 is set in the range of 0.75 seconds to 1 second, both ends inclusive. Therefore, both the production rate and the yield of the carbon nanohorn assembly 117 can be improved.

A pause width in the irradiation laser light is set, for example, not less than 0.1 seconds, and preferably not less than 0.25 seconds. Therefore, the overheating of the surface can be suppressed more securely in the graphite rod 101.

It is preferable that the pause width is set such that the pulse light irradiation condition satisfies the following expression (1) according to the pulse width:
0.5≦(pulse width)/(pulse width+pause width)≦0.8 (1)

Letting 0.5≦(pulse width)/(pulse width+pause width) in the above expression (1) enables the efficient production of the carbon nanohorn assembly 117. Further, letting (pulse width+pause width)≦0.8 allows the yield of the carbon nanohorn assembly 117 to be improved.

In the surface of the graphite rod 101, the preferable irradiation angle of the laser light 103 is as described above, and the irradiation position is moved while the irradiation angle of the pulse light is kept substantially constant. During the side face of the graphite rod 101 is irradiated with the laser light 103, the spot diameter can be set in the range of 0.5 mm to 5 mm, both ends inclusive.

The spot position which is of the irradiation position of the laser light 103 at the surface of the graphite rod 101 can be moved at a speed (linear speed) ranging from 0.01 mm/sec to 55 mm/sec, both ends inclusive. When the linear speed is increased, the generation of the carbon vaporization from the surface of the graphite rod 101 is limited to the shallow area from the surface while a length irradiated with the laser light 103 becomes longer at one-time pulse irradiation in the surface of the graphite rod 101. On the contrary, when the linear speed is decreased, the vaporization is generated to the deep area from the surface of the graphite rod 101 while the length irradiated with the laser light 103 becomes shorter at one-time pulse irradiation in the surface of the graphite rod 101.

It is speculated that the production amount of the soot-like substance per unit time, that is to say, the production rate of the soot-like substance and the yield of the carbon nanohorn assembly 117 in the produced soot-like substance depend on a movement distance of the irradiation position at one-time pulse light irradiation and the depth of the carbon vaporization. When the carbon vaporization is excessively deep, other substances except for the carbon nanohorn assembly 117 are produced to decrease the yield. When the carbon vaporization is excessively shallow, the carbon nanohorn assembly 117 is not sufficiently produced. Setting the linear speed at the above condition allows the carbon nanohorn assembly 117 to be efficiently produced at high yield.

More specifically, the movement speed of the graphite rod 101 can be set not less than 5 mm/sec, for example, and preferably not less than 10 mm/sec, which allows the carbon nanohorn assembly 117 to be efficiently produced. The movement speed of the graphite rod 101 can also be set not more than 32 mm/sec, for example, which allows the surface of the graphite rod 101 to be securely irradiated with the laser light 103.

In the present embodiment, the side face of the graphite rod 101 is irradiated with the pulse light while the graphite rod 101 which is of the cylindrical graphite target is rotated about the central axis. Since the surface of the graphite rod 101 is irradiated with the laser light 103 while the irradiation position of the laser light 103 is moved, the surface is prevented from roughening at the irradiation position, which allows the fluctuation in power density of the laser light 103 with which the surface of the graphite rod 101 to be suppressed. Therefore, the carbon nanohorn assembly 117 having the desired property can stably be produced.

Specifically, for example, in the case where the surface of the graphite rod 101 having the diameter of 100 mm is irradiated with the laser light 103, the rotating mechanism 115 rotates the graphite rod 101 having the diameter of 100 mm in the circumferential direction at constant speed, and the number of revolutions is set in the range of 0.01 rpm to 10 rpm, both ends inclusive, which allows the above linear speed to be realized. At this point, it is preferable that the number of revolutions ranges from 2 rpm to 6 rpm, both ends inclusive. Therefore, the yield of the carbon nanohorn assembly 117 can be further improved. Although the rotating direction of the graphite rod 101 is not particularly limited, it is preferable that the graphite rod 101 is rotated in the direction in which the graphite rod 101 recedes from the laser light 103. Therefore, the carbon nanohorn assembly 117 can be recovered more securely.

In irradiating with the laser light 103, the irradiation position can be moved such that the irradiation positions of the pulse light do not overlap one another in the surface of the graphite rod 101. Specifically, for example, the next pulse light irradiation is not performed to the area already irradiated with the laser light in the pulse light irradiation by controlling the rotating speed of the graphite rod 101 and the pause width of the pulse light according to the spot diameter of the laser light 103. Therefore, the fluctuation in power density can be suppressed more securely at the irradiation position in the surface of the graphite rod 101, which allows the carbon nanohorn assembly 117 having the desired property to be stably produced at high yield.

For example, the condition that the graphite rod 101 is irradiated with laser light 103 can specifically be set as follows:

Power density of the laser light 103 at the side face of the graphite rod 101: 22 kW/cm²

Pulse width of laser light 103: 1 sec

Quiescent width of laser light: 0.25 sec

Linear speed of graphite rod 101: 10 mm/sec

Accordingly, the carbon nanohorn assembly 117 can be produced more efficiently at high yield. When the surface of the graphite rod 101 having the diameter of 100 mm is irradiated with the laser light 103, the number of revolutions of the graphite rod 101 about the central axis is set at 2 rpm, which allows the linear speed of the graphite rod 101 to be set at about 10.5 mm/sec.

The soot-like substance produced with the apparatus of FIG. 1 or FIG. 3 mainly contains the carbon nanohorn assembly 117, and is recovered as the substance containing the 90 wt % or more carbon nanohorn assembly 117, for example.

As described above, the present invention is described based on the embodiments. Those skilled in the art will understand that these embodiments are illustrated by way of example only, various modifications can be made, and the modifications are also included in the scope of the invention.

For example, the apparatus of FIG. 1 or FIG. 3 has the configuration in which the soot-like substance obtained by irradiating with the laser light 103 is recovered by the nanocarbon recovery chamber 119, while it can be recovered by depositing on a proper substrate, or by the method of recovering fine particles with a dust bag. Further, the inert gas can also be circulated in the reaction chamber to recover the soot-like substance by a flow of the inert gas.

In the nanocarbon producing apparatus shown in FIG. 1 or FIG. 3, a controller which controls the action of the rotating mechanism 115 or the laser light source 111 may be further included such that the power density of the laser light 103 with which the surface of the graphite rod 101 is kept substantially constant. Therefore, the power density of the laser light 103 with which the surface of the graphite rod 101 can be controlled more securely, which allows it to be configured to produce the nanocarbon having the stable quality at high yield.

At this point, the controller may move one of the graphite rod 101 and the laser light source 111 relative to the other to move the irradiation position of the laser light 103 in the surface of the graphite rod 101. For example, the controller may be configured to have a moving unit controller, and the moving unit controller controls the irradiation angle of the laser light source 111 which emits the laser light 103 to the surface of graphite rod 101. Further, the controller may be configured to have a laser light controller, and the laser light controller emits the laser light 103 while changing outgoing light intensity of the laser light 103. Therefore, the power density of the laser light 103 with which-the surface of the graphite rod 101 can be adjusted more precisely.

In the carbon nanohorn constituting the carbon nanohorn assembly 117, the shape, the diameter size, the length, the shape of a tip end portion, the distance between carbon molecules, the distance between carbon nanohorns, and the like can be controlled in various ways depending on conditions with the laser light 103 and the like.

In the above descriptions, the graphite rod 101 is used as an example of the graphite target. However, the shape of the graphite target is not limited to the cylindrical shape. For example, the graphite target can also be formed in the sheet-shape, the bar-shape, and the like.

The present invention will further be described based on Examples. However, the present invention is not limited to the following Examples.

### EXAMPLES

In the embodiment, the carbon nanohorn assembly was produced by a laser ablation method. The rod-shaped sintered carbon having the diameter of 100 mm was used as the solid-state carbon substance which is the graphite target. The graphite target was placed in the vacuum chamber. After the chamber was evacuated up to 10⁻² Pa, the Ar gas was introduced such that an atmospheric pressure became 760 Torr (1.01325×10⁵ Pa). Then, the solid-state carbon substance was irradiated with the high-output CO₂ laser light at a room temperature for 30 min. The laser output was set at 3 kW, and the power density was set at 22 kW/cm² in the surface of the solid-state carbon substance. The pulse width and the pause width were set at the conditions of Table 1. While solid-state carbon substance was rotated at 6 rpm, for irradiation with the laser light was conducted such that the irradiation angle was set at 45 degrees. At this point, the movement speed of the irradiation position became 31.4 mm/sec.

Table 1 shows the production rate and the yield of the carbon nanohorn assembly on each irradiation condition. In Table 1 and the following Tables, “production rate” shall mean the amount of soot-like substance producing in a unit time, and “yield” shall mean the ratio of the carbon nanohorn in the soot-like substance. The carbon nanohorn was obtained in the form of carbon nanohorn assembly.

From Table 1, on the condition that the pause width is not less than 0.25 ms in the embodiment, it is found that both the production rate and the yield of the carbon nanohorn assembly are increased by setting the pulse width not less than 0.75 seconds. It is also found that both the production rate and the yield of the carbon nanohorn assembly are increased by setting (pulse width)/(pulse width+pause width) not less than 0.5, and it is found that the production rate and the yield can further be improved by setting it not less than 0.7.

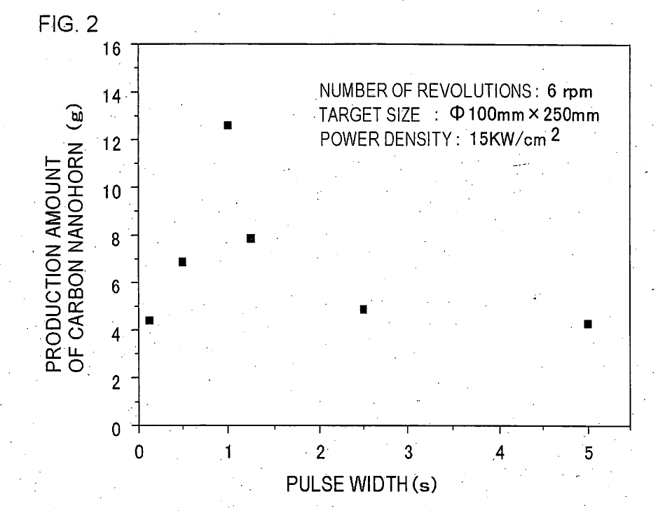

Then, when the pause width of 10 seconds was kept constant, the production amount of the carbon nanohorn assembly was studied by changing the pulse width. The power density was set at 15 kW/cm² in the surface of the solid-state carbon substance. Other conditions were set similar to the above conditions. FIG. 2 shows the result. In this study, since the pause width was set at 10 seconds, the sufficient time for eliminating the historical influence of the previous pulse light irradiation was secured. Therefore, it is thought that the result of FIG. 2 shows the pulse width suitable for the production of the carbon nanohorn assembly. As can be seen from FIG. 2, the production amount of carbon nanohorn assembly becomes the maximum when the pulse width is set at 1 second.

Further, the pulse width was set at 1 second, the pause width was set at 1 second, and the power density was set at 22 kW/cm² in the surface of the solid-state carbon substance. At this point, the relationship between the number of revolutions of the target and the production amount and the yield was studied. The number of revolutions was changed in the range of 1 rpm to 10 rpm, both ends inclusive. Other conditions were set same as the above conditions. Table 2 shows the result. When the number of revolutions ranged from 2 rpm to 6 rpm, both ends inclusive, the yields of the carbon nanohorn assembly were as high as 90%, and it is confirmed that the carbon nanohorn assembly was selectively generated. When the production amounts of soot-like substances were compared to one another in the above range of number of revolutions, it was found that the production amount was the largest at 2 rpm.

Then, the pulse width was set at 1 second in irradiating with the laser light, and the pause width was set at 0.25 seconds. At this point, the relationship between the number of revolutions of the target and the production amount and the yield was further studied. The number of revolutions was changed in the range of 1 rpm to 6 rpm, both ends inclusive. In this case, the influence of the power density on the production rate of the soot-like substance and the yield of the carbon nanohorn assembly was also studied by changing the power density of the laser light. Other conditions were set same as the above conditions.

The results are shown in Tables 3 and 4. Table 3 shows the result when the power density of the laser light was set at 15 kW/cm². Table 4 shows the result when the power density of the laser light was set at 22 kW/cm². In the both results, as with the result shown in Table 2, the yields of the carbon nanohorn assembly were as high as 90% when the number of revolutions ranged from 2 rpm to 6 rpm, both ends inclusive, the production amount was the largest at 2 rpm at the above range of the number of revolutions. As can be seen from Tables 3 and 4, the production rate of the soot-like substance is higher when the power density of the laser light was set at 22 kW/cm². Although the result is not shown, when the power density of the laser light was set more than 22 kW/cm², it was recognized that the production rate of the soot-like substance lends to be decreased.

The following conclusions are obtained from the above results. That is, the carbon nanohorn assembly can securely be produced by setting the power density of the laser light at the condition of the present examples. At this point, the production rate and the yield of the carbon nanohorn assembly mainly depend on the pulse width. On the condition that the pause width is not less than 0.25 seconds, the production rate can particularly be increased by setting the pulse width in the range of 0.75 seconds to 1 second, both ends inclusive.

The linear speed of the graphite target is set in the range of 10 mm/sec to 32 mm/sec, both ends inclusive, more specifically, the number of revolutions of the graphite rod having the diameter of 100 mm is set in the range of 2 rpm to 6 rpm, both ends inclusive, the production rate of the carbon nanohorn assembly is further increased. The production rate of the carbon nanohorn assembly is also further increased by adjusting such that the pulse width and the pause width satisfy the above expression (1). Further, the graphite rod is irradiated with the pulse light while rotated and moved such that the irradiation positions of the pulse light do not overlap one another in the surface of the graphite rod, which allows the yield of the carbon nanohorn assembly to be improved.

Further, when the graphite rod having the diameter of 100 mm is used as the graphite target, the pulse width of the laser light is set at 1 second, the pause width is set at 0.25 seconds, the number of revolutions of the graphite rod is set at 2 rpm, and the power density of the laser light is set at 22 kW/cm² in the surface of the graphite rod. Therefore, the yield and the production rate of the carbon nanohorn assembly can further be improved.

TABLE 1

| PULSE | PAUSE | (PULSE WIDTH)/ | | PRODUC- |
|---|---|---|---|---|
| WIDTH | WIDTH | (PULSE WIDTH + | YIELD | TION |
| (SECOND) | (SECOND) | PAUSE WIDTH) | (%) | RATE (g/h) |
| 1 | 1 | 0.50 | 80 | 43.2 |
| 1 | 0.75 | 0.57 | 80 | 51.0 |
| 1 | 0.5 | 0.67 | 80 | 44.8 |
| 1 | 0.25 | 0.80 | 80 | 54.4 |
| 0.75 | 0.25 | 0.75 | 80 | 62.2 |
| 0.5 | 0.5 | 0.50 | 50 | 40.6 |
| 0.25 | 0.75 | 0.25 | 38.8 | 26.0 |

TABLE 2

| PULSE | PAUSE | NUMBER OF | | PRODUC- |
|---|---|---|---|---|
| WIDTH | WIDTH | REVOLUTIONS | YIELD | TION |
| (SECOND) | (SECOND) | (rpm) | (%) | AMOUNT (g) |
| 1 | 1 | 10 | 80 | 3.7 |
| 1 | 1 | 6 | 90 | 9.1 |
| 1 | 1 | 4 | 90 | 11.5 |
| 1 | 1 | 2 | 90 | 15.9 |
| 1 | 1 | 1 | 80 | 22.5 |

POWER DENSITY: ˜15 kW/cm², Ar: 30 L/min, 760 torr

TABLE 3

| | | NUMBER | | |
|---|---|---|---|---|
| | | OF | PRODUC- | YIELD OF |
| PULSE | PAUSE | REVOLU- | TION | CARBON |
| WIDTH | WIDTH | TIONS | AMOUNT | NANOHORN |
| (SECOND) | (SECOND) | (rpm) | OF SOOT (g/h) | (%) |
| 1 | 0.25 | 1 | 71.4 | 80 |
| 1 | 0.25 | 1.5 | 72.9 | 80 |
| 1 | 0.25 | 2 | 96.8 | 90 |
| 1 | 0.25 | 3 | 93.9 | 90 |
| 1 | 0.25 | 4 | 92.4 | 90 |
| 1 | 0.25 | 6 | 86.7 | 90 |

POWER DENSITY: ˜15 kW/cm², Ar: 30 L/min, 760 torr

TABLE 4

| | | NUMBER | | |
|---|---|---|---|---|
| | | OF | PRODUC- | YIELD OF |
| PULSE | PAUSE | REVOLU- | TION | CARBON |
| WIDTH | WIDTH | TIONS | AMOUNT | NANOHORN |
| (SECOND) | (SECOND) | (rpm) | OF SOOT (g/h) | (%) |
| 1 | 0.25 | 1 | 79.8 | 80 |
| 1 | 0.25 | 1.5 | 99.3 | 80 |
| 1 | 0.25 | 2 | 106.6 | 90 |
| 1 | 0.25 | 3 | 99.3 | 90 |
| 1 | 0.25 | 4 | 98.7 | 90 |
| 1 | 0.25 | 6 | 93.3 | 90 |

POWER DENSITY: ˜22 kW/cm², Ar: 30 L/min, 760 torr

1. A method of producing a carbon nanohorn assembly including:
irradiating a surface of a graphite target with pulse light to vaporize carbon vapor from said graphite target and recovering the carbon vapor to obtain a carbon nanohorn,
wherein an irradiation position of said pulse light is moved at substantially constant speed when the surface of said graphite target is irradiated with said pulse light,
a power density of said pulse light is set in a range of 5 kW/cm² or more and 25 kW/cm² or less, and
a pulse width of said pulse light is set in a range of 0.5 seconds or more and 1.25 seconds or less.

2. The method of producing a carbon nanohorn assembly as claimed in claim 1,
wherein a pause width of said pulse light is set not less than 0.25 seconds.

3. The method of producing a carbon nanohorn assembly as claimed in claim 1,
wherein a condition of irradiation with said pulse light satisfies the following expression (1):
0.5≦(pulse width)/(pulse width+pause width)≦0.8 (1)

4. The method of producing a carbon nanohorn assembly as claimed in claim 1,
wherein the irradiation position of said pulse light is moved at a speed ranging from 0.01 mm/sec or more and 55 mm/sec or less.

5. The method of producing a carbon nanohorn assembly as claimed in claim 1,
wherein a side face of a cylindrical graphite target is irradiated with said pulse light while said graphite target is rotated about a central axis.

6. The method of producing a carbon nanohorn assembly as claimed claim 1,
wherein said irradiation position is moved while an irradiation angle of said pulse light is kept substantially constant.

7. The method of producing a carbon nanohorn assembly as claimed in claim 1,
wherein said irradiation position is moved such that said irradiation positions of said pulse light do not overlap one another in the surface of said graphite target.
